(19) United States
(12) Patent Application Publication
(10) Pub. No.: US 2025/0010371 A1
(43) Pub. Date: Jan. 9, 2025

(54) Metal droplet deposition system

(71) Applicant: Fluent Metal Inc., Cambridge, MA (US)

(72) Inventors: Matthew McCambridge, Lexington, MA (US); Peter Schmitt, Brookline, MA (US)

(21) Appl. No.: 18/725,638

(22) PCT Filed: Nov. 22, 2022
(86) PCT No.: PCT/US2022/050699

§ 371 Date: Jun. 28, 2024

Related U.S. Application Data
(60) Provisional application No. 63/288,897, filed on Dec. 13, 2021.
(60) Provisional application No. 63/281,919, filed on Nov. 22, 2021.

(51) Int. Cl. B22F 10/22; B22F 12/13; B22F 12/57; B33Y 10/00

(52) U.S. Cl. CPC B22F 10/22; B22F 12/13; B22F 12/57; B33Y 10/00; B22F 2998/10

(57) ABSTRACT

Implementations described and claimed herein provide a system and method of creating molten metal droplets. The molten metal droplets may be used for 3D printing and or additive manufacturing. The system comprises a printhead and a heat source. The heat source melts a portion of a solid metal feedstock to form a metal droplet.

### CROSS-REFERENCE TO RELATED APPLICATIONS

The present application claims priority to U.S. Provisional Patent Application No. 63/281,919, entitled “IMPROVED METAL DEPOSITION SYSTEM” and filed on Nov. 22, 2021, and U.S. Provisional Patent Application No. 63/288,897, entitled “CONTACT SURFACE METAL DROPLET DEPOSITION SYSTEM” and filed on Dec. 13, 2021. Each of these applications is specifically incorporated by reference herein in its entirety.

### FIELD

Aspects of the present disclosure generally relate to systems and methods for three-dimensional (3D) metal printing and more particular to systems and methods for generating molten metal droplets on demand.

### BACKGROUND

Various 3D structures may be manufactured using a variety of materials. For example, 3D metal structures may be formed through 3D printing by depositing layers of liquid metal onto a build-platform. Some metal additive manufacturing processes involve directing molten metal along a trajectory. However, such processes encounter challenges with consistency and repeatability of the trajectory, scalability of metal throughput, managing the high temperature materials and the complexity of the control systems, and loss in efficiency with time between failures, among other difficulties. These challenges are exacerbated with respect to timing, efficiency, and quality when the processes involve a reservoir of molten metal and nozzle(s) for generating the molten metal.

### SUMMARY

Implementations described and claimed herein address the foregoing problems by providing systems and methods for 3D printing. In one implementation, a solid metal feedstock is obtained. A metal mass is separated from the solid metal feedstock by applying a force, and a molten metal droplet is formed by heating the metal mass. The molten metal droplet travels along a trajectory towards a build platform, and a 3D structure is formed by depositing the molten metal droplet at a target location at the build platform.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example system for 3D printing by depositing molten metal.

FIG. 2 shows an example printhead.

FIGS. 3A-3C show various views of an example printhead.

FIGS. 4A-4E show an example sequence used to create metal droplets.

FIGS. 5A-5H shows various example heat sources.

FIGS. 6A-6D show an example sequence used to create metal droplets.

FIG. 7A shows an example printhead.

FIG. 7B shows an enlarged view of a portion of the printhead of FIG. 7A.

FIG. 8 shows an example contact surface.

FIGS. 9A-E shows an example sequence used to create metal powder.

FIGS. 10A-D shows an example sequence used to separate a droplet from solid feedstock.

FIG. 11 illustrates an example computing system configured to implement various operations.

### DETAILED DESCRIPTION

Aspects of the presently disclosed technology relate to systems and methods of creating 3D structures, such as objects and/or parts, using molten metal droplets generated from solid metal feedstock, including, without limitation, a bar, a tape, a mass of metal powder, wire (e.g., microwire), and/or the like. Generally, 3D structures are created through 3D printing and/or additive manufacturing by generating and dispensing molten metal droplets onto a build-platform in layers on-demand. A metal mass may be separated from a solid metal feedstock (e.g., wire, microwire, bar, tape, powder mass, etc.) by applying a force, with a molten metal droplet being formed by heating the metal mass. This process of separation and melting need not happen continuously but may happen to produce each individual droplet as needed on demand. The metal mass may be melted prior to separation from the solid metal feedstock and/or after separation from the solid metal feedstock (e.g., in-flight after a velocity is imparted on the metal mass). The force may be an impact force (e.g., by chopping, severing, etc.), an aerodynamic force, a compression force, and/or the like. The molten metal droplet is directed along a trajectory towards a build platform, and a 3D structure is formed by depositing the molten metal droplet at a target location at the build platform, such as on a surface of the build platform, on a portion of the 3D structure (e.g., on a previously formed layer, in a layer being formed, etc.), and/or the like.

In one example, a printhead severs a portion of a solid metal feedstock, such as a metal wire, and propels the metal particle from the printhead with a predetermined velocity and position. A molten metal droplet is formed by melting the metal particle during flight using a heat source, prior to contacting a build platform.

In another example, a molten metal droplet is formed at a portion of a solid metal feedstock, such as a tip of a metal wire, by heating the portion. The portion may be melted until a droplet having a diameter larger than a diameter of the solid feedstock forms. An actuated contact surface may impart a force separating the molten metal droplet from the solid metal feedstock and causing the molten metal droplet to move along a trajectory towards a build platform. Alternatively or additionally, a flow of gas may be maintained at a velocity sufficient to impart an aerodynamic force causing the molten metal droplet to separate from the solid metal feedstock and move towards the build platform.

In another example, the solid metal feedstock includes powder stock. A mass of metal is separated from the powder stock in the form of a known volume of powder at a known density, for example, through a compression force. The mass is propelled into a heating area where the mass is melted into molten metal droplet and directed towards a build platform.

Various other examples will be apparent from the present disclosure. Overall, the presently disclosed technology generates molten metal droplets on-demand, while avoiding the challenges involves with using reservoirs, nozzles, guide channels, evaporation, and the like. The separation of a molten metal droplet may be more predictable with the presently disclosed technology, and the timing of this separation may also be more predictable. Additionally, the presently disclosed technology creates droplets of a higher temperature and from different types of metal. Further, in some example where a metal particle is heated in flight, there is no residue on a printhead from molten metal, thereby increasing efficiency by reducing system maintenance and failures.

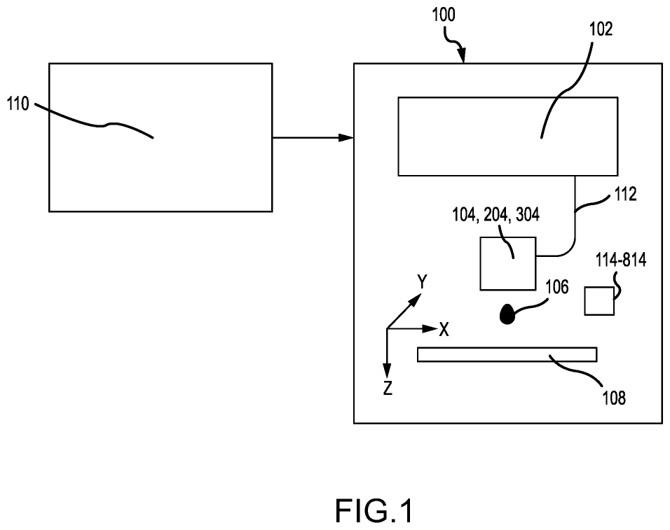

To begin a detailed discussion, reference is made to FIG. 1, which shows a 3D printing system 100 for generating molten metal droplets on-demand for creating 3D structures, such as parts and/or objects. In one implementation, the 3D printing system 100 comprises a solid metal feedstock, including, but not limited to, metal wire source(s), metal bar(s), metal tape(s), metal powder stock, and/or the like.

For example, the solid metal feedstock may include a metal wire source 102. The metal wire source 102 may be, without limitation, one or more metal microwire cartridges, spools, supplies, and/or the like. The metal wire source 102 may contain one or more metal wires 112, which the same or different types of metal. A printhead 104 may be in communication with the one or more metal wire sources 102.

In one implementation, the printhead 104 generates molten metal droplets 106 that are ejected towards a build platform 108 positioned relative to the printhead 104. Each of the molten metal droplets 106 is deposited on a target location at the build platform 108, thereby forming a 3D structure made from metal, such as one or more metal objects, metal parts, and/or the like. The 3D structure is formed from one or more metal layers, which are created by depositing the molten metal droplets 106. In this manner, the target location of each of the molten metal droplets 106 may be on a surface of the build platform 108 and/or on another portion of the 3D structure, such as a previously deposited layer or droplet, relative to a previously deposited droplet (e.g., within a same layer), and/or the like. The 3D structure may have a shape formed according to printing instructions directed by a controller 110.

In one implementation, the print instructions are generated by a computing system, which may be part of or in communication with the controller 110. The printing instructions may be generated, for example, based on a 3D model of the 3D structure. The computer system may include a personal computer, terminal, workstation, mobile device, smartphone, tablet, and/or the like. The computer system may be in communication with the printhead 104 and any other portions of the 3D printing system 100 via a wired (e.g., Universal Serial Bus, Ethernet, etc.) or wireless connection (e.g., WiFi, Bluetooth, etc.). For example, the 3D printing system 100 may include a network interface for facilitating communication with the computer system via a network. The printing instructions may be obtained at the controller 110 of the 3D printing system 100 via the wired or wireless connection. In another example, the printing instructions are received at the 3D printing system 100 from the computer system via removable memory. It will be appreciated that the printing instructions may be obtained by the controller 110 in various manners including directly where the computing system is part of the controller 110.

The print instructions may include one or more profiles, shapes, thicknesses, and/or other features of one or more portions of the 3D structure, each of which may be customizable using the computing system. The print instructions may further include parameters of the molten metal droplets 106 and deposition characteristics. For example, the print instructions may specify a droplet diameter, droplet temperature, printing speed, layer height, layer width, target location for the molten metal droplet 106, and/or the like, which also may be customizable. The controller 110 controls the generation of the molten metal droplets 106 and the deposition of the molten metal droplets 106 at the build platform 108 according to the print instructions.

In one implementation, a 3D model is a representation of the 3D structure, which may include a plurality of sub-models for parts of the 3D structure. The 3D model is sliced into a plurality of outlines, such as a series of sequential cross-sections of the 3D model. The plurality of outlines is used to generate the printing instructions for the 3D structure. The print instructions may be in a format ingestible by the controller 110, the printhead 104, and/or other components of the 3D printing system 100. The printing instructions define the actions of one or more components of the 3D printing system during manufacturing of the 3D structure. The controller 110 is configured to direct the actions of the one or more components according to the printing instructions. The 3D printing system 100 manufactures one or more portions of the 3D structure using an additive process in which the molten metal droplets 106 are deposited to form layer by layer at the build platform 108. The printing instructions may control the generation of the molten metal droplets 106 using a controlled advancement of a metal mass, such as metal wire 112, from the solid metal feedstock in the form of the one or more metal wire source 102.

The advancement of the metal wire 112 from the metal wire source 102 to the printhead 104 may be achieved through the use of a piezo actuator, a stepper motor, a voice-coil and/or any other suitable means of grasping and moving wire at a controlled rate. A single actuator may be used to advance the metal wire 112. However, it will be appreciated that multiple actuators working together may be used to advance the metal wire 112.

In one implementation, the printhead 104 ejects metal particles at a maximum frequency. The printhead 104 may contain a single chopper or an array of choppers, each being supplied with the same or different types of the metal wire 112. The printhead 104 ejects the metal particles along a trajectory towards the build platform 108 using the choppers. Additionally, the printhead 104 is capable of skipping one or multiple particles, also referred to as drop on demand. In an X-Y plane, the printhead 104 and the build platform 108 move relative to each other either in a vector, tool-path trajectory, in a rastering scanning motion, and/or the like. In some cases, the ejected metal particles are melted along the trajectory in midflight by a heat source 114, and the resulting molten metal droplets 106 are deposited at a target location in a layer according to the printing instructions sent by the controller 110. As noted above, the 3D structure is built up from one or more layers. The printhead 104 and the build platform 108 may also move relative to each other in a Z-direction.

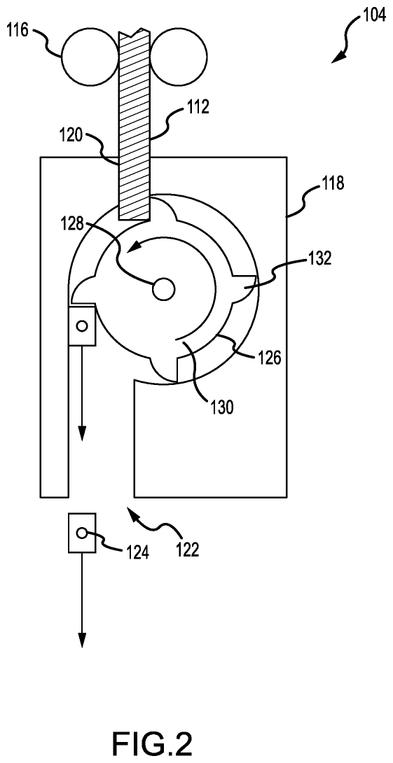

Turning to FIG. 2, which shows an expanded view of the printhead 104, it will be appreciated that an actuator 116 may be used to advance the metal wire 112 toward the printhead 104. The actuator 116 may be, without limitation, a piezo actuator, a stepper motor, a voice-coil, and/or the like.

In one implementation, the printhead 104 includes a frame 118, which receives the metal wire 112. The frame 118 includes an inlet 120, through which the metal wire 112 enters the frame 118. The frame 118 also includes an outlet 122, through which metal particles 124 exit. A chopper 126 may be positioned within the frame 118. The chopper 126 is rotated about a central axis 128, with the central axis 128 being orthogonal to a direction that the metal wire 112 advances. The chopper 126 may be controlled by a motor, such as a rotary motor. A body 130 of the chopper 126 may have teeth 132 extending radially outward from the body 130. The body 130 may have a variety of shapes, such as a cylindrical shape.

In accordance with the printing instructions, the actuator 116 advances the metal wire 112 into the inlet 120. The wire 112 may be advanced until the tip of the metal wire 112 contacts the body 130 of the chopper 126. In this way, a length of a portion of the metal wire 112 that is to be cut is consistent in forming the metal particles 124. The rotation of the chopper 126 about the central axis 128 causes one of the teeth 132 to contact a portion of the metal wire 112 that is extended through the inlet 120 with an impact force. In this manner, the impact force caused by the continued rotation of the chopper 126 causes the portion of the metal wire 112 to be severed from the rest of the metal wire 112. The severed portion of the metal wire 112 is advanced by the teeth 132 until the severed portion of the metal wire 112 reaches the outlet 122, where the several portion of the metal wire 112 separates from the frame 118 as the metal particle 124. The metal particle 124 is directed along a trajectory towards the build platform 108 at a velocity generated by gravity as the metal particle 124 drops from the frame 118 and/or by movement of the chopper 126. More particularly, in some instances, the rotation of the chopper 126 imparts an outgoing velocity to the metal particle 124.

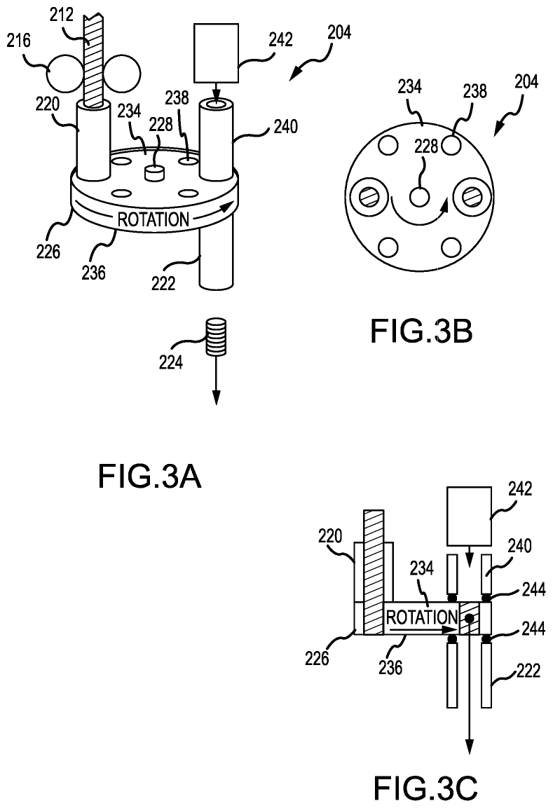

Turning to FIGS. 3A-3C, in one example, an actuator 216 may be used to move a metal wire 212 towards a printhead 204. The actuator 216 may be a piezo actuator, a stepper motor, a voice-coil, and/or the like

In one implementation, the printhead 204 comprises an inlet 220 and an outlet 222. The inlet 220 and outlet 222 may be fixed in position. The printhead 204 also includes a chopper 226. The chopper 226 comprises a top surface 234 having one or more openings 238. The chopper 226 also comprises a bottom surface 236 having one or more openings. The top surface 234 and bottom surface 236 may be separated by a predetermined distance to create a volume therebetween. Sliding seals 244 may be disposed between the ejection tube 240 and the top surface 234 and between the outlet 222 and the bottom surface 236.

The chopper 226 rotates about a central axis 228. The central axis 228 may be parallel to the direction that the metal wire 212 is being advanced. As the chopper 226 rotates, one of the one of more openings 238 in the top surface 234 aligns with the inlet 220. The actuator 216 advances the metal wire 212, such that a tip of the metal wire 212 contacts the bottom surface 236. In this way, a length of a portion of the metal wire 212 that is to be cut is consistent. As the chopper 226 continues to rotate, the top surface 234 serves as a shear surface to sever the portion of the metal wire 212 disposed in the volume between the top 234 and bottom 236 surfaces. As the chopper 226 continues to rotate, the one or more openings 238 aligns with an ejection tube 240. The ejection tube 240 may be fixed in place and aligned with the outlet 222 on an opposite side of the chopper 236.

In one implementation, the ejection tube 240 is in communication with a propellant gas source 242. When the one or more openings 238 are aligned with the ejection tube 240, propellant gas expelled from the propellant gas source 242 forces a portion of the metal wire 212 that is disposed in the volume between the top 234 and bottom 236 surfaces to be expelled through the outlet 222 as a metal particle 224. In other words, the propellant gas imparts a velocity to the metal particle 224.

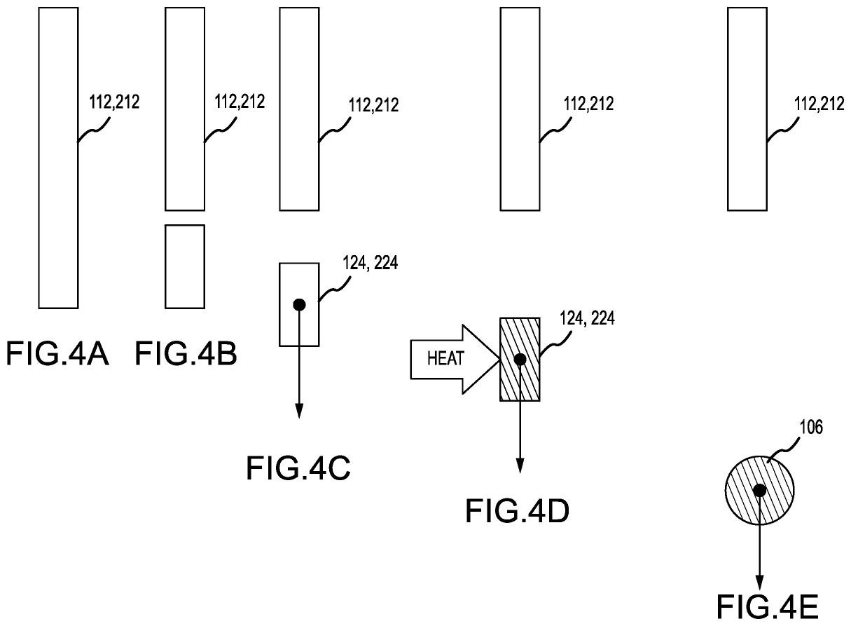

Referring to FIGS. 4A-4E, the metal wire 112, 212 is advanced, as shown in FIG. 4A. Next, as shown in FIG. 4B, a portion of the metal wire 112, 212 is severed from the rest of the metal wire 112, 212 using an impact force generated by the chopper 126, 226. An initial velocity with appropriate magnitude and direction is imparted to this portion of the metal wire 112, 212, as it exits the printhead 104, 204 as a metal particle 124, 224, as shown in FIG. 4C. As the metal particle 124, 224 is in flight, it is subjected to heat from the heat source 114, as shown in FIG. 4D. This heat transforms the metal particle 124, 224 into the molten metal droplet 106, which continues along its previously imparted trajectory towards the build platform 108 for depositing at a target location. Because of this sequence, the molten metal droplet 106 has a known velocity, position, temperature and mass. The shown sequence can be repeated according to the printing instructions. In some instances, these steps can be pipelined in that one metal particle 124, 224 is heated (see FIG. 4D) while a portion of the metal wire 112, 212 is being severed (see FIG. 4B) to create the next metal particle 124, 224.

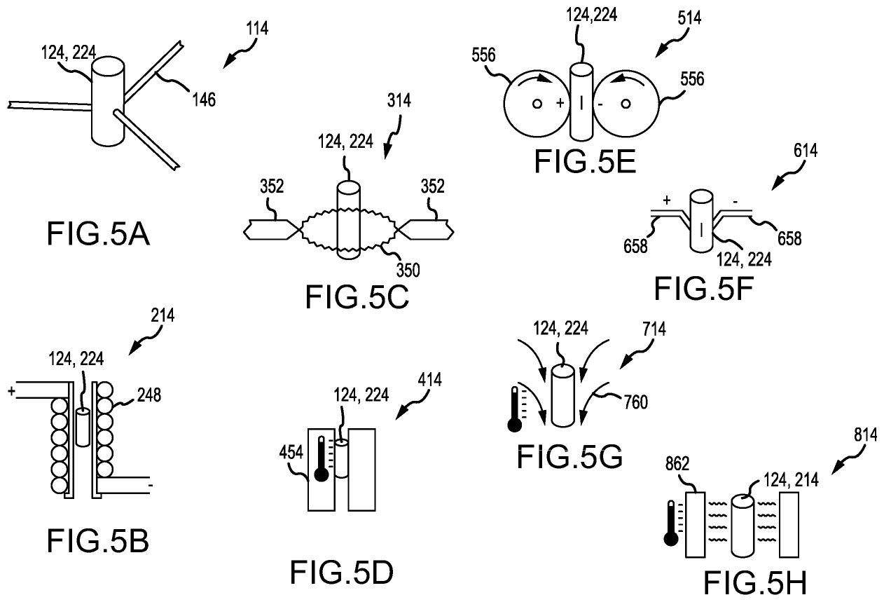

FIGS. 5A-5F show examples of the heat source 114. Turning first to FIG. 5A, the heat source 114 may include one or more laser beams 146 focusing light at the metal particle 124, 224. The light may travel through a fiber optic cable, for example. The fiber optic cable may include a lens to focus the emergent beam at the metal particle 124, 224. The energy from the laser beam 146 causes the metal particle 124, 224 to transition from a solid to a liquid, so as to form the molten metal droplet 106.

In another implementation illustrated in FIG. 5B, the heat source 114 includes an induction heat source 214 including an induction coil 248 to heat a tip of the metal particle 124, 224 to create the molten metal droplet 106. The induction coil 248 at least partially encircles a path of the metal particle 124, 224. In other words, after the metal particle 124, 224 is released by the chopper 126, 226, the metal particle 124, 224 travels along the path to pass through the induction coil 248. The quantity of power applied to the induction coil 248 may be determined according to the properties of the induction coil 248 and the material, diameter, and length of the metal particle 124, 224 within it, as controlled according to the print instructions. When power is applied to the induction coil 248, the metal particle 124, 224 is heated and transitions to the liquid state, so as to form the molten metal droplet 106.

In another implementation illustrated in FIG. 5C, the heat source 114 includes a plasma heat source 314 that creates a plasma arc 350 between two electrodes 352 by applying an electric potential across a gap disposed between the electrodes 352, which may or may not be filled with gas other than air, such as, shield gas. A voltage applied to the electrodes 352 may be an alternating current (AC) or direct current (DC) voltage. The magnitude of the voltage may be determined, for example, based on the distance between the electrodes 352, the mass and size of the metal particle 124, 224 and the type of metal used. The voltage may be applied to one electrode or both electrodes 352. Those skilled in the art may readily determine the appropriate magnitude of the voltage based on these parameters. The plasma arc 350 is hot enough to melt the metal particle 124, 224 from solid to liquid, so as to form the molten metal droplet 106.

In another implementation illustrated in FIG. 5D, the heat source 114 includes a conduction heat source 414. The metal particle 124, 224 may contact one or more heated plates 454 after it is released by the chopper 126, 226. The plates 454 may be heated using any suitable method, such as resistive heaters, light energy, and/or the like. In some examples, the heated plates 454 may form a channel through which the metal particle 124, 224 is directed. For example, the heated plates 454 may comprise a hollow tube though which the metal particle 124, 224 travels.

In another implementation illustrated in FIG. 5E, the metal particle 124, 224 is heated by a heat source 514 via resistive heating, where a current is passed through the metal particle 124, 224 in flight as it moves along the trajectory towards the build platform 108. The trajectory includes the metal particle 124, 224 falling between two rotating wheels 556. The rotating wheels 556 may be rotated in opposite directions, so as to impart an exit velocity on the metal particles 124, 224. The rotating wheels 556 may be biased at different voltages, such that when the metal particle 124, 224 falls between and contacts both rotating wheels 556, a current is passed through the metal particle 124, 224. The amount of current may be sufficient to transition the metal particle 124, 224 from solid form to liquid, thereby creating the molten metal droplet 106.

In another implementation illustrated in FIG. 5F, a heat source 614 heats the metal particle 124, 224 via resistive heating using at least two wires 658 that extend into the path of the metal particle 124, 224, such that as the metal particle 124, 224 travels, it contacts the at least two wires 658. These wires are at different voltages, such that the metal particle 124, 224 conducts electricity as it passes the at least two wires 658. The amount of current may be sufficient to transition the metal particle 124, 224 from solid form to liquid, creating the molten metal droplet 106.

In another implementation illustrated in FIG. 5G, the metal particle 124, 224 is heated by a convection heat source 714. In this implementation, hot gas 760, such as heated air, is circulated near the metal particle 124, 224 as it travels towards the build platform 108, thereby transitioning the metal particle 124, 224 from solid to liquid and creating the molten metal droplet 106.

In another implementation illustrated in 5H, thermal energy is used by a thermal heat source 814 to heat the metal particle 124, 224. In this implementation, one or more heated masses 862 may be placed near the path of the metal particle 124, 224 as it travels towards the build platform 108. Heat from the heated masses 862 may be sufficient to cause the metal particle 124, 224 to transition from solid form to liquid, thereby creating the molten metal droplet 106. In certain implementations, one or more of the heat sources 114 (e.g., one or more of the heat sources 214-814) may be arranged in series such that the metal particle 124, 224 passes through more than one heat source before reaching the build platform 108. Additional heat sources may be disposed prior to or after the metal particle 124, 224 has transitioned to the molten metal droplet 106 to ensure that the molten metal droplet 106 is at the desired temperature when it reaches the build platform 108. The heat source(s) 114 may be under separate control from each other, and controllable in real time, such that the quantity of heat added to the molten metal droplet 106 by any subsequent heat source can be varied based on a measured and/or inferred temperature of the molten metal droplet 106. The temperature of the molten metal droplet 106 can be directly measured by a variety of solid-state sensing technologies, such as, for example, infrared sensors. This task is made more reasonable by the fact that much is known about the other properties of the molten metal droplet 106, such as the material and mass of the molten metal droplet 106. Droplet temperature may also be inferred by measurements of the energy actually put into the molten metal droplet 106 during preceding steps, as it may be possible to more precisely measure the energy that was transferred to any given droplet, as compared to the nominal energy intended to be transmitted to droplets according to the printing instructions and/or calibrated parameters of the 3D printing system 100. Droplet temperature may be adjusted to approach a desired temperature by adding a variable amount of energy, varying energy in proportion to a difference between measured and desired temperature, and/or the like.

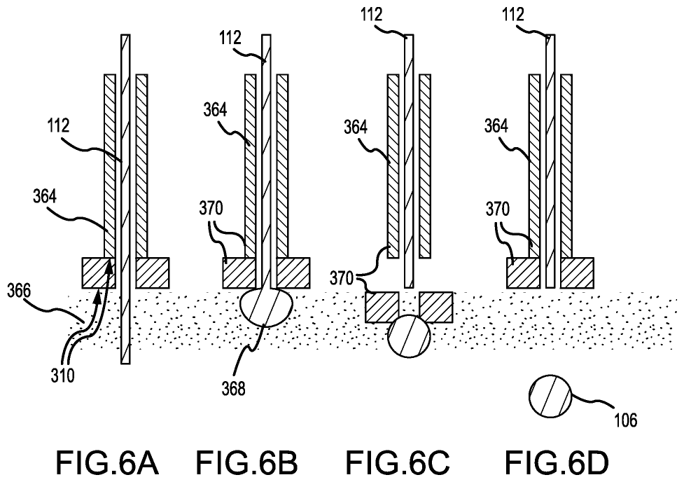

FIGS. 6A-6D shows example operations of a printhead 304. In one example of a drop-on-demand operation mode, every time the molten metal droplet 106 is needed, as shown in FIG. 6A, the metal wire 112 is being fed by the actuator 116 through a guide channel 364. The metal wire 112 extends beyond the guide channel 364 into a heat zone 366. As described below, the heat zone 366 may be created using the heat source 114, which may be any suitable heat source (e.g., heat sources 214-814), such as a laser, an induction coil, a plasma source, and/or the like, as described herein

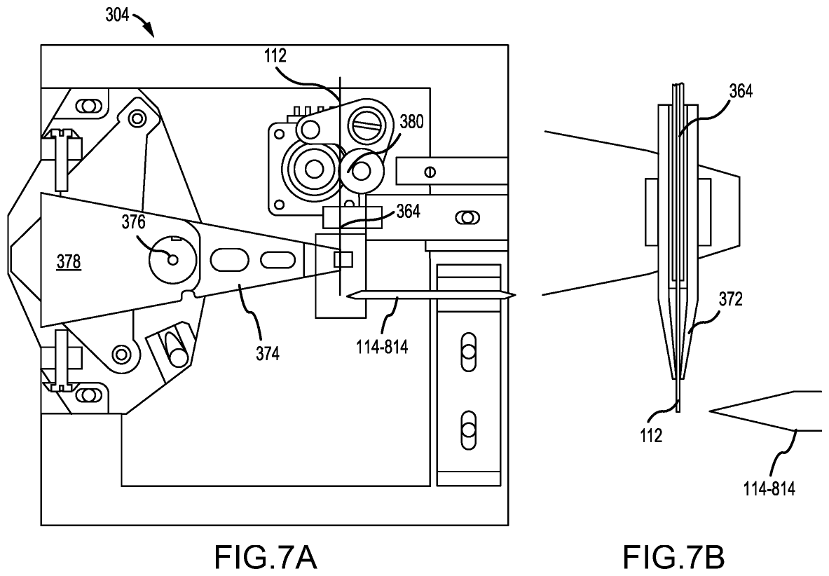

As shown in FIG. 6B, a tip of the metal wire 112 in the heat zone 366 melts and forms a molten sphere 368 at the tip of the wire 112. The molten sphere 368 may come in contact with a contact surface 370. In some implementations, the contact surface 370 may be an end or a face of the guide channel 364. In some implementations, such as that shown in FIG. 7B, a separate element, such as a capillary 372, is added at or near the end of the guide channel 364. The end and/or face of this separate component serves as the contact surface 370.

In operation, as shown in FIG. 6C, an actuator, such as a motor, piezo, pneumatic, magnetic mechanism, and/or the like as described herein, moves the contact surface 370 with respect to the metal wire 112, causing the molten sphere 368 to separate from the metal wire 112. When the contact surface 370 reaches a maximum travel distance, it reverses and returns to an original position while the molten sphere 368 separates from the contact surface 370 as the molten metal droplet 106. The length of travel may be set so as to accomplish separation of the molten metal droplet 106 from the metal wire 112 and to impart sufficient velocity to the molten metal droplet 106 as desired for printing, within a maximum acceleration appropriate to a size and a material of the molten metal droplet 106.

As shown in FIG. 6D, in one implementation, the molten metal droplet 106 maintains its trajectory after separating from the contact surface 370. If the contact surface 370 is moved at the same velocity for each molten sphere 368, the trajectory of each successive metal droplet 106 may be nearly identical.

The mechanism of separating the molten sphere 368 from the metal wire 112 is possible whenever the dimensions of the molten sphere 368 and the metal wire 112 and the properties of the metal wire 112 are such that the cohesive force maintaining a force of the molten sphere 368 in a generally spherical shape is larger than a force holding the molten sphere 368 to the metal wire 112. In one non-limiting example, the molten sphere 368 is approximately 0.175 mm or greater in diameter, the metal wire 112 is approximately 0.100 mm in diameter, and the material of the metal wire 112 is 6061 aluminum.

Referring to FIGS. 7A-7B, an example printhead 304 is shown with the heat source 114 (e.g., 214-814) is disposed proximate the tip of the metal wire 112. In one implementation, the heat source 114 comprises an electrically conductive electrode, biased using a high voltage power supply. In this way, a large voltage is created between the metal wire 112, which may be negatively charged, and the positively charged electrode. This large voltage causes an electrical discharge forming a plasma arc between the end of the metal wire 112 and the tip of the electrode. This arc is of sufficient energy so as to cause the melting of a short portion of the end of the metal wire 112. The melted short portion forms a sphere of molten metal 368 at the end of the metal wire 112. The electrode may be of a size, geometry, and material to withstand many such electrical discharges without degradation of performance. It will be appreciated, however, that other heat sources, such as lasers, induction coils, and others, as described above, may be used to form the molten sphere 368 at the tip of the metal wire 112.

FIG. 7B shows an enlarged view of the tip of the metal wire 112 and the supporting structures. In one implementation, the metal wire 112 is fed through the guide channel 364. A separate component, such as capillary 372, may be disposed proximate to the end of the guide channel 364. The capillary 372 is movable relative to the guide channel 364 and to the metal wire 112. The capillary 372 is made of a material that is non-wetting in the presence of molten metal. The capillary 372 may serve as the contact surface 370, as described above.

Returning to FIG. 7A, in one implementation, the contact surface 370 is the end of the capillary 372. The capillary 372 may be moved by lever arm 374 around pivot point 376. This movement may be created by any type of actuator. Electromagnets 378 are disposed near a distal end of the lever arm 374 within a strong magnetic field. This allows the lever arm 374 to move in a highly repeatable manner, similar to the manner of a scanning head of a magnetic disk drive, for example. The metal wire 112 may be fed through the guide channel 364, and the position of the metal wire 112 along its axis is controlled by a drive roller 380 rotated by a stepper motor.

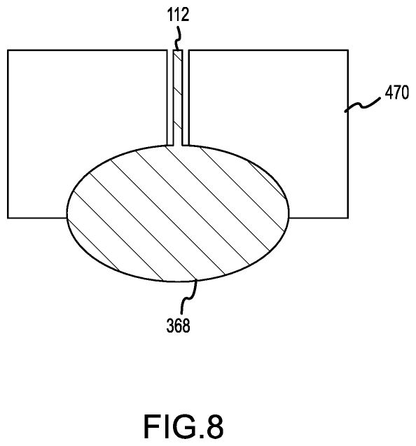

In some implementations, the contact surface 370 may be planar. However, in other implementations, as shown in FIG. 8, the contact surface 470 has a concave shape to facilitate sphere placement and force-implanting areas.

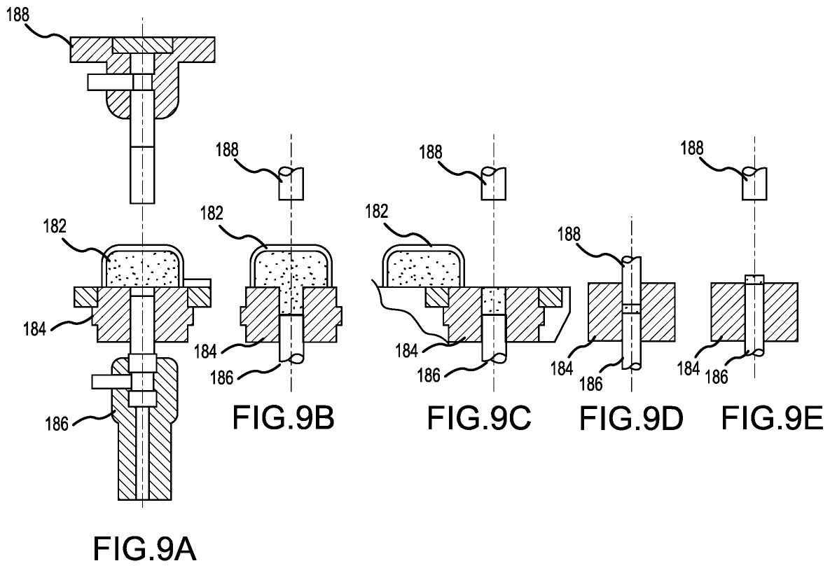

Turning to FIGS. 9A-9E, in one implementation, the solid metal feedstock is metal powder stock. The metal powder stock may be of a single particle size or a range of particle sizes. For instance, the metal powder stock may be loose or mechanically compacted using a press operation. FIGS. 9A-9E show an example sequence used to create mechanically compacted metal powder. FIG. 9A shows a feed shoe 182 containing a metal powder stock positioned over a die 184. In FIG. 9B, a lower punch 186 is retracted to allow a metal mass from the metal powder stock to fill the die 184. In FIG. 9C, the feed shoe 182 is moved away from the die 184 when the metal mass reaches a threshold within the die 184. In FIG. 9D, an upper punch 188 is lowered into the die 184 to apply a compression force to compress the metal powder disposed in the die 184. In FIG. 9E, the upper punch 188 is moved away from the die 184 and the lower punch 186 is moved upward to eject the compressed metal powder from the die 184 for melting to form the molten metal droplet 106.

The metal powder may contain additional additives to increase or reduce cohesion between the particles. The 3D printing system 100 provides separation of a known mass of the metal powder from the metal powder stock, such as, for example, by a known volume of metal powder at a known density. The metal mass is propelled into an area where heating and melting occurs to produce a uniform droplet of known mass as the molten metal droplet 106.

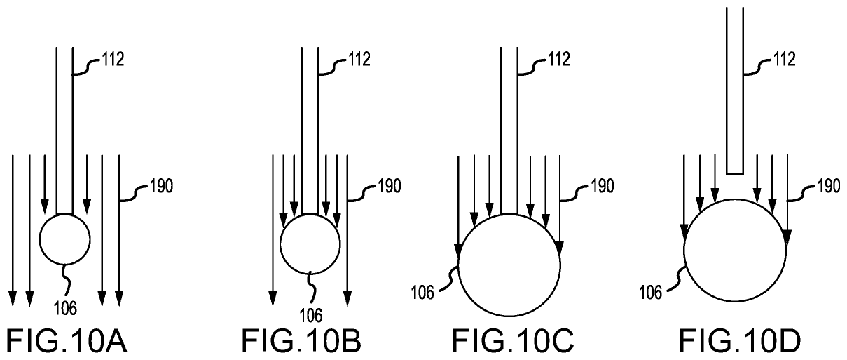

Referring to FIGS. 10A-D, it will be appreciated that separation of the molten metal droplet 106 from the metal wire 112 may be accomplished using aerodynamic forces applied by a gas 190. In one implementation, the molten metal droplet 106 is separated from the metal wire 112 by maintaining a constant flow of the gas 190 at a high velocity, such that when the droplet reaches a certain critical diameter the aerodynamic force causes the molten metal droplet 106 to separate from the metal wire 112. The gas 190 may be air and may provide additional functions, such as, the displacement of oxygen for prevention of corrosion and/or a beneficial chemical reaction. Additionally, the gas 190 may be heated or cooled to a temperature which is advantageous to the process of creating the molten metal droplet 106 and/or regulating its temperature. In one implementation, the flow of the gas 190 is symmetrically applied around the metal wire 112 and the molten metal droplet 106.

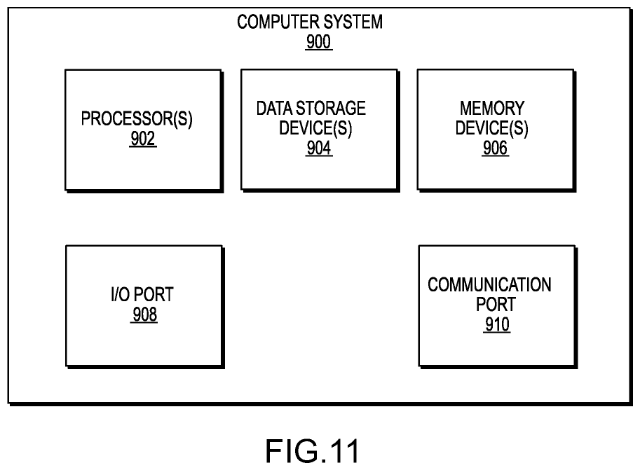

Referring to FIG. 11, a detailed description of an example computing system 900 having one or more computing units that may implement various systems and methods discussed herein is provided. The computing system 900 may be applicable to the controller 110, various components of the 3D printing system 100, and other computing systems, controller, and/or network devices or units. It will be appreciated that specific implementations of these devices may be of differing possible specific computing architectures not all of which are specifically discussed herein but will be understood by those of ordinary skill in the art.

The computer system 900 may be a computing system is capable of executing a computer program product to execute a computer process. Data and program files may be input to the computer system 900, which reads the files and executes the programs therein. Some of the elements of the computer system 900 are shown in FIG. 11, including one or more hardware processors 902, one or more data storage devices 904, one or more memory devices 906, and/or one or more ports 908-910. Additionally, other elements that will be recognized by those skilled in the art may be included in the computing system 900 but are not explicitly depicted in FIG. 11 or discussed further herein. Various elements of the computer system 900 may communicate with one another by way of one or more communication buses, point-to-point communication paths, or other communication means not explicitly depicted in FIG. 11.

The processor 902 may include, for example, a central processing unit (CPU), a microprocessor, a microcontroller, a digital signal processor (DSP), and/or one or more internal levels of cache. There may be one or more processors 902, such that the processor 902 comprises a single central-processing unit, or a plurality of processing units capable of executing instructions and performing operations in parallel with each other, commonly referred to as a parallel processing environment.

The computer system 900 may be a conventional computer, a distributed computer, or any other type of computer, such as one or more external computers made available via a cloud computing architecture. The presently described technology is optionally implemented in software stored on the data stored device(s) 904, stored on the memory device(s) 906, and/or communicated via one or more of the ports 908-910, thereby transforming the computer system 900 in FIG. 11 to a special purpose machine for implementing the operations described herein. Examples of the computer system 900 include personal computers, terminals, workstations, mobile phones, tablets, laptops, personal computers, multimedia consoles, gaming consoles, set top boxes, and the like.

The one or more data storage devices 904 may include any non-volatile data storage device capable of storing data generated or employed within the computing system 900, such as computer executable instructions for performing a computer process, which may include instructions of both application programs and an operating system (OS) that manages the various components of the computing system 900. The data storage devices 904 may include, without limitation, magnetic disk drives, optical disk drives, solid state drives (SSDs), flash drives, and the like. The data storage devices 904 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 906 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 904 and/or the memory devices 906, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 900 includes one or more ports, such as an input/output (I/O) port 908, a communication port 910, and any other ports for communicating with other computing, network, or printing devices. It will be appreciated that the ports 908-910 may be combined or separate and that more or fewer ports may be included in the computer system 900.

The I/O port 908 may be connected to an I/O device, or other device, by which information is input to or output from the computing system 900. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 900 via the I/O port 908. Similarly, the output devices may convert electrical signals received from computing system 900 via the I/O port 908 into signals that may be sensed as output by a human, such as sound, light, and/or touch. The input device may be an alphanumeric input device, including alphanumeric and other keys for communicating information and/or command selections to the processor 902 via the I/O port 908. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 900 via the I/O port 908. For example, an electrical signal generated within the computing system 900 may be converted to another type of signal, and/or vice-versa. In one implementation, the environment transducer devices sense characteristics or aspects of an environment local to or remote from the computing device 900, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 900, such as, physical movement of some object (e.g., a mechanical actuator), heating or cooling of a substance, adding a chemical substance, and/or the like.

In one implementation, a communication port 910 is connected to a network by way of which the computer system 900 may receive network data useful in executing the methods and systems set out herein as well as transmitting information and network configuration changes determined thereby. Stated differently, the communication port 910 connects the computer system 900 to one or more communication interface devices configured to transmit and/or receive information between the computing system 900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 910 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G)) network, or over another communication means. Further, the communication port 910 may communicate with an antenna for electromagnetic signal transmission and/or reception.

In an example implementation, printing instructions and software and other modules and services for 3D printing and molten metal droplet generation and deposition may be embodied by instructions stored on the data storage devices 904 and/or the memory devices 906 and executed by the processor 902. The computer system 900 may be integrated with or otherwise form part of the controller 110 or other components of the 3D printing system 100.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, the present disclosure have been described in the context of particular implementations as non-limiting examples. Functionality may be separated or combined in blocks differently in various embodiments of the disclosure or described with different terminology. These and other variations, modifications, additions, and improvements may fall within the scope of the disclosure as defined in the claims that follow.

1. A method for three-dimensional (3D) printing, the method comprising:
obtaining a solid metal feedstock;
separating a metal mass from the solid metal feedstock by applying a force, a molten metal droplet being formed by heating the metal mass, the molten metal droplet traveling along a trajectory towards a build platform; and
forming a 3D structure by depositing the molten metal droplet at a target location at the build platform.

2. The method of claim 1, wherein the force is at least one of an impact force, a compression force, or an aerodynamic force.

3. The method of claim 1, wherein the solid metal feedstock includes at least one of a bar, a tape, powder, or wire.

4. The method of claim 1, wherein the metal mass is melted prior to separation from the solid metal feedstock.

5. The method of claim 1, wherein the metal mass is melted after separation from the solid metal feedstock.

6. The method of claim 1, wherein the metal mass is melted in-flight along the trajectory.

7. The method of claim 1, wherein the molten metal droplet has at least one of a predetermined velocity, a predetermined position, or a predetermined mass.

8. The method of claim 1, further comprising:
forming a metal particle by severing the metal mass from the solid metal feedstock; and
expelling the metal particle along the trajectory with a velocity.

9. The method of claim 1, wherein the metal mass is melted using a first heat source to form the molten metal droplet, a second heat source supplying additional heat to the molten metal droplet until a predetermined temperature is reached.

10. The method of claim 9, wherein a temperature of the molten metal droplet after passing the first heat source is determined, the additional heat supplied by the second heat source determined based on the temperature of the molten metal droplet.

11. The method of claim 1, further comprising:
forming a molten sphere from the metal mass;
separating the molten sphere from the solid metal feedstock by applying the force; and
releasing the molten sphere as the molten metal droplet along the trajectory.

12. The method of any of claim 1, wherein the force is applied using at least one of a movable contact surface as the impact force or a flow of gas as the aerodynamic force.

13. A system adapted to perform the method of claim 1, the system comprising:
an actuator operable to advance the solid metal feedstock;
a printhead operable to receive the solid metal feedstock;
at least one heat source operable to heat the metal mass; and
the build platform operable to receive the molten metal droplet at the target location.

14. The system of claim 13, further comprising:
a chopper disposed in the printhead and configured to sever the metal mass from the solid metal feedstock, the metal mass being released through an outlet of the printhead as the metal particle with the velocity.

15. The system of claim 13, further comprising:
a chopper comprising a body with one or more teeth extending radially outward from the body, the printhead comprising a frame comprising an inlet and an outlet, the chopper being disposed in the frame and operable to rotate about a central axis such that the teeth sever a portion of the solid metal feedstock extending through the inlet as the metal mass and release the metal mass through the outlet as a metal particle.

16. The system of claim 13, further comprising:
a chopper comprising a top surface with one or more openings and a bottom surface separated from the top surface to create a volume therebetween, the printhead comprising a frame including an inlet and an outlet, the chopper rotating about a central axis such that the top surface severs a portion of the solid metal feedstock extending through the inlet as the metal mass and releasing the metal mass through the outlet as a metal particle.

17. The system of claim 13, wherein the at least one heat source comprises one or more of: laser beams, an induction coil, a plasma arc generated by one or more electrodes, one or more heated plates that heat the portion via conduction, at least two rotating wheels operable to rotate in opposite directions and biased at different voltages, and at least two wires biased at different voltages.

18. The system of claim 13, wherein the at least one heat source utilizes resistive heating to melt the metal mass.

19. The system of claim 13, wherein the at least one heat source melts the metal mass to form a molten sphere, the system further comprising the movable contact surface, wherein the movable contact surface is operable to separate the molten sphere from the solid metal feedstock and release the molten sphere as the molten metal droplet.

20. The system of claim 13, wherein the solid metal feedstock travels through a guide channel, an end of the guide channel comprises the moveable contact surface.

21. The system of claim 13, wherein the solid metal feedstock travels through the guide channel and a separate component is disposed proximate to an end of the guide channel, the separate component comprising the contact surface.

22. The system of claim 13, wherein the contact surface is at least one planar or concave.
